(19) United States
(12) Patent Application Publication
(10) Pub. No.: US 2026/0118488 A1
(43) Pub. Date: Apr. 30, 2026

(54) Method for adjusting the operating point of an avalanche photodiode

(71) Applicants: Andreas Perger, Wien (AT); Leica Camera AG, Wetziar (DE)

(72) Inventor: Andreas Perger, Wien (AT)

(21) Appl. No.: 19/367,664

(22) Filed: Oct. 23, 2025

(30) Foreign Application Priority Data
Oct. 24, 2024 (AT) A50849/2024

(51) Int. Cl. G01S 7/4861; G01S 7/497; G01S 17/10

(52) U.S. Cl. CPC G01S 7/4861; G01S 7/497; G01S 17/10

(57) ABSTRACT

A method for adjusting the operating point of an avalanche photodiode is provided, in which the supply voltage of the avalanche photodiode is changed gradually and the total noise and the amplifier noise of an amplifier connected to the avalanche photodiode are determined, wherein the supply voltage is kept constant after reaching a certain ratio between the total noise and the amplifier noise.

### BACKGROUND OF THE INVENTION

The invention relates to a method for adjusting the operating point of an avalanche photodiode.

The invention further relates to a device for measuring the distance between a location and an object.

Since the 1990s, laser rangefinders based on the pulse-time-of-flight method have also become widely used in the consumer sector. They are used primarily in golf and hunting, but also by sport shooters, in water sports, and other recreational activities. The measuring range of such rangefinders is a few hundred meters to a few kilometers, and the accuracy is typically around one meter, which is usually sufficient for the aforementioned applications. Suitable targets are usually those that reflect diffusely rather than directly, such as trees and bushes, but also artificial objects. For consumer applications, it is of course important that the lasers used are eye-safe.

The price of such a product is also important and crucial for mass distribution. Therefore, it is important to ensure that the rangefinder components can be manufactured cost-effectively. Laser rangefinders for the above-mentioned applications typically consist of the electronic part (including optoelectronic components), as well as optical and mechanical parts. While the mechanical parts hold all components securely in place and protect them from external influences, the optical components (generally consisting of the objective, inversion system, and eyepiece, as well as optics for transmitting and receiving the laser radiation) serve to visualize and target the measured object. The optical system can be designed for monocular or binocular observation.

The electronic component essentially consists of a transmitter and a receiver for the laser beam, as well as a signal processing and display unit. The signal processing unit also integrates the operation, control of the display, and power supply. Additional components such as an inclinometer, compass, temperature and air pressure sensors, and the like can also be added. Laser diodes have become established as transmitters, while avalanche photodiodes (APDs) have become established as the receivers, both with associated electronic circuits. Avalanche photodiodes are diodes with an internal amplification mechanism, enabling them to detect even weak optical signals and even individual photons. Furthermore, the transmitter and receiver require optics to collimate the laser beam toward the target and to project the laser light reflected from the target onto the receiver, wherein the aforementioned observation optics can also be used if necessary. Optical components are also required to reflect the display into the observation beam path (see EP 1 069 442 B1).

As mentioned, the rangefinders described here operate according to the pulse-time-of-flight method, which means they measure the time it takes for a laser pulse to travel from the transmitter to the target and back to the receiver. For this purpose, the receiver signal is sampled and digitized after a laser pulse has been emitted, and the resulting digital data is evaluated to determine the distance to the target object.

When measuring very long distances, which can be several kilometers, the amount of light reaching the receiver diode is very small. This is due to the very low energy of laser diodes in consumer products for safety reasons, as well as the fact that with natural targets, the laser pulse is reflected within a solid angle of 2*π, meaning only a very small portion reaches the rangefinder's receiver. Thus, the portion of the laser pulse reflected back from the target and reaching the receiver diode consists of only a few photons at long distances.

For these reasons, as mentioned above, the use of avalanche photodiodes has become established. But there is another key reason for the use of avalanche photodiodes: the photodiode's output signal is always too weak to be directly converted into a digital signal. Therefore, an analog amplifier is connected between the photodiode and the analog/digital converter. However, this amplifier has inherent noise. When using an avalanche photodiode, it receives an input signal that is amplified many times over, which improves the signal-to-noise ratio (SNR) accordingly.

To adjust the operating point of the avalanche photodiode's supply voltage, the state of the art uses a fixed, preset supply voltage, which is compensated, i.e., adjusted, if necessary, based on a measured temperature. However, this method has the disadvantage that it is not precise, and the supply voltage is therefore not always optimally adjusted.

A further disadvantage of this known method arises from its behavior at low background radiation. At very low background radiation, the desired noise level is only achieved with a very high internal gain of the avalanche photodiode (multiplication factor M). These internal gains can be significantly higher than the nominal value and thus close to the breakdown voltage of the photodiode. Due to the high-impedance circuitry of the avalanche photodiode's power supply, it is protected from damage. However, the noise in this range is no longer approximately Gaussian-distributed, as is the case with shot noise and thus the noise of PIN photodiodes and avalanche photodiodes in the normal gain range (e.g., with a multiplication factor M<100 for silicon or 10 to 30 for InGaAs), but instead, numerous noise peaks are superimposed on the noise, leading to an incorrect calculation of the operating point and, consequently, to a suboptimal signal-to-noise ratio. The presence of such noise peaks would therefore have to be monitored separately when using the RMS value of the noise to control the supply of the avalanche photodiode.

### SUMMARY OF THE INVENTION

It is therefore an object of the invention to provide a method for adjusting the operating point of an avalanche photodiode that enables precise adjustment and, particularly at low background radiation, the achievement of a better signal-to-noise ratio. In particular, the method according to the invention should make it possible to find the optimal operating point of an APD at any temperature, any background radiation intensity, and regardless of sample variations.

### BRIEF DESCRIPTION OF DRAWINGS

FIG. 1 shows a schematic representation of the method according to the invention.

FIG. 2 shows the relationship between the additional noise factor and the multiplication factor.

FIG. 3 shows the voltage dependence of the sensitivity of APDs at different temperatures.

FIG. 4 shows the dependence of the SNR on the multiplication factor at different intensities of the background radiation.

### DETAILED DESCRIPTION OF THE INVENTION

According to the invention, a method of the type mentioned at the outset is provided in which the supply voltage of the avalanche photodiode is changed gradually and the total noise and the amplifier noise of an amplifier connected to the avalanche photodiode are determined, wherein the supply voltage is kept constant after reaching a certain ratio between the total noise and the amplifier noise. Preferably, the supply voltage of the avalanche photodiode (APD) is gradually (step by step) increased until the desired ratio is reached. The APD and the amplifier are connected in such a way that signals from the APD can be transmitted to the amplifier, amplified by the amplifier, and output as the amplifier's output signal. Thus, in a first step, a supply voltage is applied, and then the ratio between the total noise and the amplifier noise (at this supply voltage) is determined. The total noise is the noise of the APD and the amplifier combined. The amplifier noise is the noise caused exclusively by the amplifier itself. The supply voltage is then either held and the actual distance measurement is carried out when the desired ratio between the total noise and the amplifier noise is reached, or the supply voltage is changed, particularly increased if the desired ratio has not yet been reached. After adjusting the supply voltage, the ratio is determined again at the changed supply voltage and compared with the desired value. This is repeated until the desired ratio and thus the optimal operating point is reached and the actual distance measurement can be carried out. The supply voltage is held during the distance measurement.

Preferably, the operating point of an avalanche photodiode (APD) used as a receiver in a rangefinder is set with the inventive method. During the measurement, light pulses are emitted by a transmitter of the rangefinder, and the light pulses reflected by the target object are received by an avalanche photodiode and then further processed. The distance to the target object can be determined from the received signal strength and the time of reception. The signals received by the APD are first amplified in an amplifier and then preferably fed to an A/D converter, which samples the signals in a clocked manner and digitizes them accordingly. The data or series of values obtained in this way can, for example, be arranged in a histogram, which makes it possible to determine the distance to the target object.

The principles of the invention will be explained first. The most important parameters to be considered in the following are the internal gain of the avalanche photodiode (multiplication factor M), which is based on charge carrier multiplication through impact ionization, and the factor k, which describes the ratio of the ionization coefficients of the electrons to that of the holes. This factor influences the additional noise factor F(M), which will be used further below, as follows:

$$F ( M ) = kM + ( 1 - k ) * ( 2 - 1 / M )$$

For silicon, a material often used in avalanche photodiodes (APDs), k is typically 0.02, and for InGaAs (indium gallium arsenide), which is used for longer wavelengths, k is 0.45 to 0.50.

For the optimization of APD operation described below, an approximation for F (M) is used that has proven to be more than adequately accurate. It is

$$F ( M ) = {M}^{X}$$

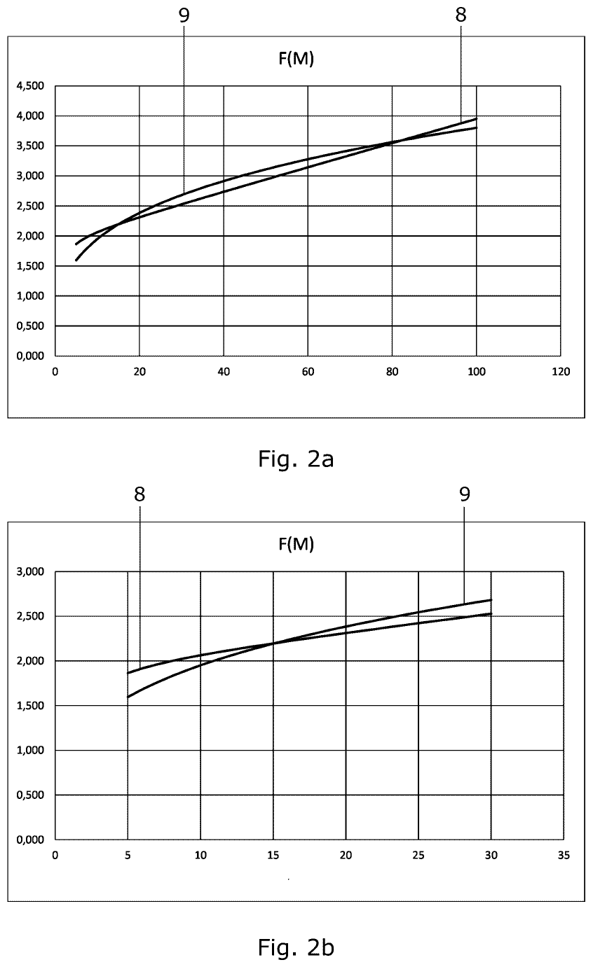

Approximately, X=0.3 for silicon APDs and X=0.7 to 0.85 for InGaAs APDs. This relationship is also explained below in FIG. 2.

Other quantities for characterizing the behavior of avalanche photodiodes are the surface leakage current (I_{DS}) and the bulk leakage current (I_{DB}). The former is not amplified, while the latter is, resulting in the total dark current (I_{D})

$${I}_{D} = {I}_{DS} + {I}_{DB} * M$$

For PIN photodiodes, the noise is

$${I}_{N} = √ ( 2 q * B * ( {I}_{D} + {I}_{P} ) )$$

where q is the elementary charge, B is the bandwidth, Ip is the dark current of the photodiode, and Ip is the photocurrent.

For the avalanche photodiode, the corresponding relationship is

$${I}_{N} = √ ( 2 q * B * ( {I}_{DS} + ( {I}_{DB} + {I}_{P} ) * {M}^{2} * F ( M ) ) )$$

For further considerations, the input-related noise of the subsequent amplifier I_{NVV} must be included: The total noise is thus

$${I}_{N} = √ ( {{I}_{NVV}}^{2} + 2 q * B * ( {I}_{DS} + ( {I}_{DB} + {I}_{P} ) * {M}^{2} * F ( M ) ) )$$

For the application described here in consumer laser rangefinders, the photocurrent Ip, which results from the illumination of the target, especially in daylight, dominates, so that the surface leakage current Ips can be neglected.

Thus, the signal-to-noise ratio is

$$SNR = {I}_{S} * M / √ ( {{I}_{NVV}}^{2} + 2 q * B * ( {I}_{DB} + {I}_{P} ) * {M}^{2} * F ( M ) )$$

where I_{S} is the current of the wanted signal, which originates from the light pulses reflected from the target, especially laser pulses.

To generate the impact ionization required for charge carrier multiplication, a supply voltage U_{B} of typically several hundred volt is applied to the avalanche photodiode. However, in the operation described here, this voltage is always below the breakdown voltage.

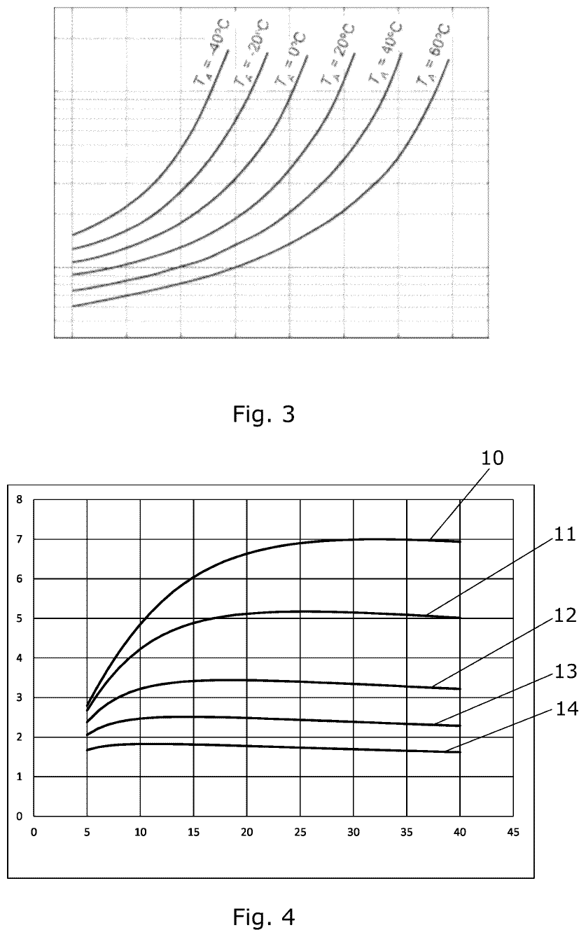

The dependence of the multiplication factor M on the supply voltage is strongly influenced by temperature and sample variations (see FIG. 3). Therefore, the voltage U_{B} is usually set individually for each sample, and the temperature dependence is compensated with the help of a temperature sensor to achieve the desired multiplication factor M. The nominal value of this multiplication factor is usually 100 for silicon APDs and between 10 and 30 for InGaAs APDs.

In rangefinder applications with a significant influence of background radiation, the nominal value of the multiplication factor M usually does not result in the maximum SNR. Especially for silicon APDs, the optimal multiplication factor M is significantly below 100 in daylight. This is also illustrated in FIG. 4.

The present invention demonstrates a simple method with which the optimal operating point of an APD can be found at any temperature, any intensity of background radiation, and regardless of sample variations. To first calculate this optimal operating point, the expression for the SNR is derived with respect to M and set to 0.

$$dSNR / dM = 0$$

By transforming and inserting, one finally obtains the relationship

$${I}_{N} / {I}_{NVV} = √ ( 2 / X - 1 )$$

This relationship per se is well known.

The value for I_{N}/I_{NVV} is around 2.8 for silicon and around 2 for InGaAs. This means that the supply voltage U_{B} of the APD is increased until the total noise has increased to, for example, 2.8 times (for silicon) or 2 times (for InGaAs) the amplifier noise I_{NW}.

Preferably, the total noise and/or the amplifier noise is determined by sampling and digitizing the amplifier output signal. Preferably, both the amplifier noise and the total noise are determined by sampling and digitizing the amplifier output signal. Particularly preferably, a large number of samples (e.g., several hundred; 300, 400 or 500) are recorded before the supply voltage U_{B} of the APD is turned on in order to determine the amplifier noise. Sampling is performed using the A/D converter without light pulses being emitted by a transmitter. Since the amplifier noise is subject to only slight sample variations, a fixed value can also be assumed for this. The supply voltage U_{B} of the APD is now increased in increments, e.g., of a few volts and by recording of, for example, several hundred samples each and determining, for example, the peak-to-peak value, the supply voltage value is reached at which the total noise I_{N} has increased by, for example, the aforementioned factor of 2.8 or 2 compared to the amplifier noise I_{NW}. This supply voltage is then maintained during a distance measurement. No light pulses are emitted by the transmitter until the desired ratio between the total noise and the amplifier noise is reached, i.e., until the corresponding supply voltage is reached.

Sampling by an A/D converter is preferably performed in a clocked manner and therefore comprises multiple sampling cycles. Sampling can occur, for example, at a frequency of 10 MHz.

Light pulses are preferably laser pulses. The duration of the light pulses is typically in the range of a few tens of nanoseconds (ns). The light pulses are directed onto the object as an (almost) parallel beam, e.g., using an objective.

It is preferably provided that the supply voltage is varied, in particular increased, by a fixed value, e.g., 1 to 20 volts, preferably 2 to 10 volts, until the desired signal-to-noise ratio is reached.

Alternatively, it is preferably provided that the supply voltage is changed, in particular increased, by a value that depends on the last determined noise ratio, i.e. the ratio between the total noise and the amplifier noise. For example, the supply voltage can be changed by a larger value if the difference between the desired noise ratio and the determined noise ratio is relatively large. If, on the other hand, the difference between the desired noise ratio and the determined noise ratio is relatively small, the supply voltage is only changed by a smaller value. This procedure has the advantage that, on the one hand, the desired noise ratio is reached relatively quickly, since larger steps are made at the beginning when changing, in particular the increase, and, on the other hand, the desired noise ratio is achieved relatively precisely, since only small adjustments to the supply voltage are made close to the desired noise ratio. The disadvantage is the greater effort compared to changing by a fixed value in each case.

Furthermore, it is preferably provided that the supply voltage is reduced if a signal-to-noise ratio is determined that exceeds the desired signal-to-noise ratio. In the event that the supply voltage has been increased too much, it is possible to achieve the desired signal-to-noise ratio by reducing the supply voltage (once or several times). After the reduction, the ratio between the total noise and the amplifier noise is determined again and compared with the desired value. The supply voltage is then adjusted again or, if the desired value has been reached, the measurement is performed.

It is preferably provided that the total noise and/or the amplifier noise is determined by determining the peak-to-peak value. This reduces the computational effort and time required to determine the optimal supply voltage. Alternatively, other algorithms or methods for calculating the total noise or the amplifier noise are also possible.

It is preferably provided that the supply voltage is increased to a ratio of 2:1 between the total noise and the amplifier noise and then held. This is the ideal ratio for InGaAs avalanche photodiodes.

It is preferably provided that the supply voltage is increased to a ratio of 2.8:1 between the total noise and the amplifier noise and then held. This is the ideal ratio for silicon avalanche photodiodes.

To further reduce computational requirements, it is preferably provided that a plurality of sample values is measured by the avalanche photodiode before increasing the supply voltage of the avalanche photodiode, and the amplifier noise is determined from these sample values.

Furthermore, it is preferably provided that after each increase in the supply voltage of the avalanche photodiode, the ratio between the total noise and the amplifier noise is determined. The supply voltage is first adjusted, in particular slightly increased, e.g., by a few volts, and then the ratio of total noise to amplifier noise is determined. If the desired ratio is reached, the corresponding supply voltage is maintained and the measurement is performed. If the desired ratio is not yet reached, the supply voltage is slightly adjusted again, and the ratio of total noise to amplifier noise is determined. This process is continued until the desired ratio is reached.

The avalanche photodiode is preferably part of a rangefinder. In addition to the APD, a transmitter for emitting light pulses, an amplifier for amplifying the signals received by the APD, an A/D converter for evaluating and digitizing the signals received by the amplifier, a (micro) controller for controlling the individual components, an output device for displaying the measurement result, i.e., the measured distance, and optical elements are preferably provided.

The invention further provides a device of the type mentioned at the outset, which is designed to carry out the method according to the invention and comprises at least a transmitter, an avalanche photodiode, and an amplifier.

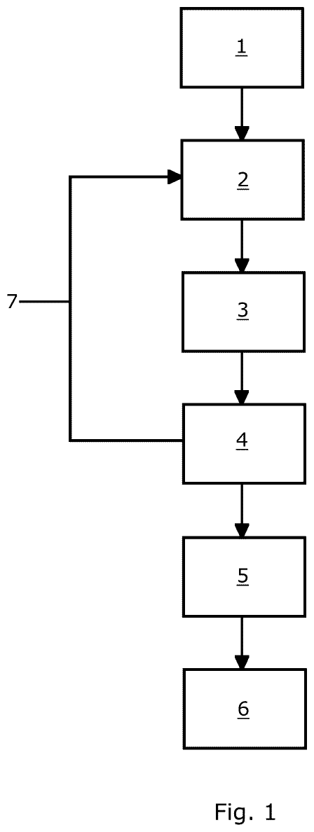

The method according to the invention is shown schematically in FIG. 1. In step 1, (optional) preparatory steps are carried out, such as measuring a large number of sample values by the avalanche photodiode in order to determine the amplifier noise from these sample values. Subsequently, in step 2, the supply voltage of the avalanche photodiode is increased, e.g., by a few volts. In step 3, the ratio between the total noise and the amplifier noise at the current supply voltage is determined. Based on this, it is determined in step 4 whether the ratio between the total noise and the amplifier noise has reached a desired, preset value, e.g., 2.8 for silicon APDs or 2 for InGaAs APDs. If this is the case, the current supply voltage is maintained, and in step 5, the actual distance measurement is carried out by emitting light pulses from a transmitter and detecting the corresponding reflected light pulses by the APD. Finally, in step 6, the signals received by the avalanche photodiode are amplified in the amplifier and then converted into digital signals, evaluated, and output accordingly. If it is detected in step 4 that the ratio between the total noise and the amplifier noise has not yet reached the desired, preset value, the process in step 2 is carried out according to arrow 7, i.e. the supply voltage is increased, then in step 3 the ratio between the total noise and the amplifier noise at the current supply voltage is determined, and then in step 4 the determined ratio is again compared with the desired value. This loop 7 is repeated until the ratio has reached the desired value in step 4 and the distance measurement (step 5) can be carried out.

FIG. 2a and FIG. 2b show the relationship between the additional noise factor F (M) (vertical y-axis) and the multiplication factor M (horizontal x-axis). FIG. 2a shows the relationship for a silicon APD and FIG. 2b for an InGaAs APD. 8 denotes the course of the additional noise factor F (M), calculated using the factor k, which describes the ratio of the ionization coefficients of the electrons to that of the holes. 9 denotes the course of the additional noise factor F (M), calculated using the material-dependent factor X, where X is, for example, 0.3 for silicon and 0.7 to 0.85 for InGaAs. It can be seen that the calculation using the factor X represents a good approximation across the entire bandwidth.

FIG. 3 shows the voltage dependence of the sensitivity of APDs at different temperatures. The horizontal x-axis represents the voltage in volts, and the vertical y-axis represents the sensitivity in amperes per watt (A/W). It is evident that the sensitivity is strongly dependent on temperature and that appropriate compensation is therefore necessary.

FIG. 4 shows the dependence of the signal-to-noise ratio (vertical y-axis) on the multiplication factor M (horizontal x-axis) at different background radiation intensities in daylight, wherein 10 denotes the SNR at a background radiation of 1 nW, 11 the SNR at a background radiation of 2 nW, 12 the SNR at a background radiation of 5 nW, 13 the SNR at a background radiation of 10 nW, and 14 the SNR at a background radiation of 20 nW. It can be seen that the optimal multiplication factor M, at which the highest signal-to-noise ratio is achieved, is well below 100.

1. A method for adjusting the operating point of an avalanche photodiode, in which the supply voltage of the avalanche photodiode is changed gradually and the total noise and the amplifier noise of an amplifier connected to the avalanche photodiode are determined, wherein the supply voltage is kept constant after reaching a certain ratio between the total noise and the amplifier noise.

2. The method according to claim 1, wherein the total noise is determined by sampling and digitizing the amplifier output signal.

3. The method according to claim 1, wherein the amplifier noise is determined by sampling and digitizing the amplifier output signal.

4. The method according to claim 1, wherein the total noise is determined by determining the peak-to-peak value.

5. The method according to claim 1, wherein the amplifier noise is determined by determining the peak-to-peak value.

6. The method according to claim 1, wherein the supply voltage is increased to a ratio of 2:1 between the total noise and the amplifier noise and then held.

7. The method according to claim 1, wherein the supply voltage is increased to a ratio of 2.8:1 between the total noise and the amplifier noise and then held.

8. The method according claim 1, wherein a plurality of sample values is measured before increasing the supply voltage of the avalanche photodiode, and the amplifier noise is determined from these sample values.

9. The method according to claim 1, wherein after each increase in the supply voltage of the avalanche photodiode, the ratio between the total noise and the amplifier noise is determined.

10. A device for measuring the distance between a location and an object for carrying out a method according to claim 1, comprising at least one transmitter, an avalanche photodiode, and an amplifier.
